(19) United States
(12) Patent Application Publication
(10) Pub. No.: US 2003/0193879 A1
(43) Pub. Date: Oct. 16, 2003

(54) Suspension device

(75) Inventors: Kuo-Chu Huang, Taoyuan (TW); Chao-Liang Chen, Taipei (TW)

Correspondence Address: QUINTERO LAW OFFICE, 1617 BROADWAY, 3RD FLOOR, SANTA MONICA, CA, 90404, US

(73) Assignee: Accesstek Inc.

(21) Appl. No.: 10/284,000

(22) Filed: Oct. 30, 2002

(30) Foreign Application Priority Data
Apr. 12, 2002 (TW) 91204857

(51) Int. Cl. G11B 23/00; G11B 25/00

(52) U.S. Cl. 369/263

(57) ABSTRACT

A suspension device for an optical media storage device having a spindle motor. The suspension device includes a loader, a traverse and a dynamic mass. The traverse is disposed on the loader and has a first weighted end. The mass center of the traverse is on the first weighted end and the spindle motor is disposed on the first weighted end. The dynamic mass is disposed on the traverse and has a second weighted end. The mass center of the dynamic mass is on the second weighted end and the second weighted end is located above the first weighted end. Thus, when the spindle motor operates, the vibration of the optical media storage device is reduced tremendously.

### BACKGROUND OF THE INVENTION

1. Field of the Invention

The present invention relates to a suspension device for an optical media storage device, and in particular to a suspension device reducing vibration caused by the optical media storage device.

2. Description of the Related Art

Generally speaking, an optical media storage device, such as an optical disk drive, is composed of a loader, a traverse, a dynamic mass and a spindle motor. The spindle motor is disposed on the traverse. The dynamic mass balances and eliminates vibration caused by rotation of the spindle motor. In addition, multiple isolators are disposed between the traverse and the loader and multiple dampers are disposed between the traverse and the dynamic mass for absorbing shock. Nevertheless, the positions of the mass centers of the conventional dynamic mass and traverse are not optimum. Also, the arrangement of the isolators and dampers is not optimum.

FIG. 1 is a schematic view showing a conventional suspension device 1 of an optical disk drive. The mass centers of the dynamic mass 11 and the traverse 12 are close to the middle of the suspension device 1. Because of this arrangement of the suspension device 1, the measured vibration values of the suspension device 1 fluctuate drastically in different directions.

FIG. 2 is a schematic view showing another conventional suspension device 2 of an optical disk drive. The dynamic mass 21 is disposed between the traverse 22 and the loader 23. The damper 24 is disposed between the traverse 22 and the dynamic mass 21. The isolator 25 is disposed between the traverse 22 and the loader 23. This arrangement only changes the positions of the damper 24 and the isolator 25. The mass center of the traverse 22 is still close to the middle of the suspension device 2. Thus, the measured vibration values of the suspension device 2 also fluctuate drastically in different directions.

Consequently, the invention provides a suspension device reducing vibration effectively. The positions of the mass centers of the dynamic mass and the traverse are adjusted simultaneously. Meanwhile, the positions of the isolators and dampers are adjusted. Thus, vibration caused by the optical media storage device is reduced tremendously.

### SUMMARY OF THE INVENTION

An object of the invention is to provide a suspension device for an optical media storage device having a spindle motor. The suspension device comprises a loader, a traverse and a dynamic mass. The traverse is disposed on the loader and has a first weighted end. The mass center of the traverse is on the first weighted end and the spindle motor is disposed on the first weighted end. The dynamic mass is disposed on the traverse and has a second weighted end. The mass center of the dynamic mass is on the second weighted end and the second weighted end is located above the first weighted end. Thus, when the spindle motor operates, the vibration of the suspension device is reduced tremendously.

Preferably, the optical media storage device is an optical disk drive.

Preferably, a plurality of isolators are disposed between the traverse and the loader, and the plurality of isolators are disposed close to the corners of the traverse.

Preferably, a plurality of dampers are disposed between the dynamic mass and the traverse, and the plurality of dampers are disposed close to the positions of the isolators.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing a conventional suspension device of an optical disk drive;

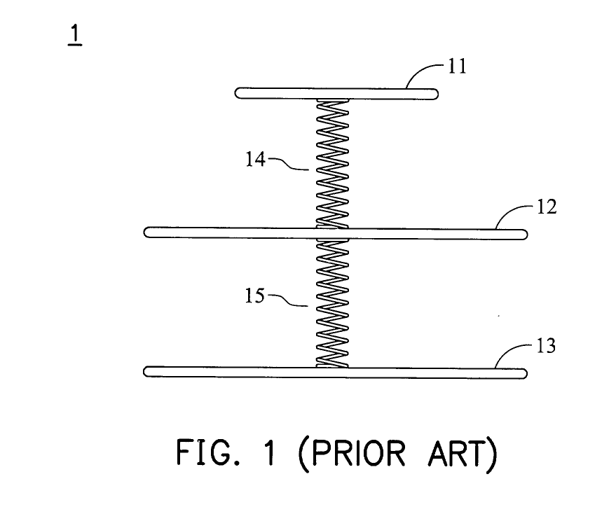

FIG. 2 is a schematic view showing another conventional suspension device of an optical disk drive;

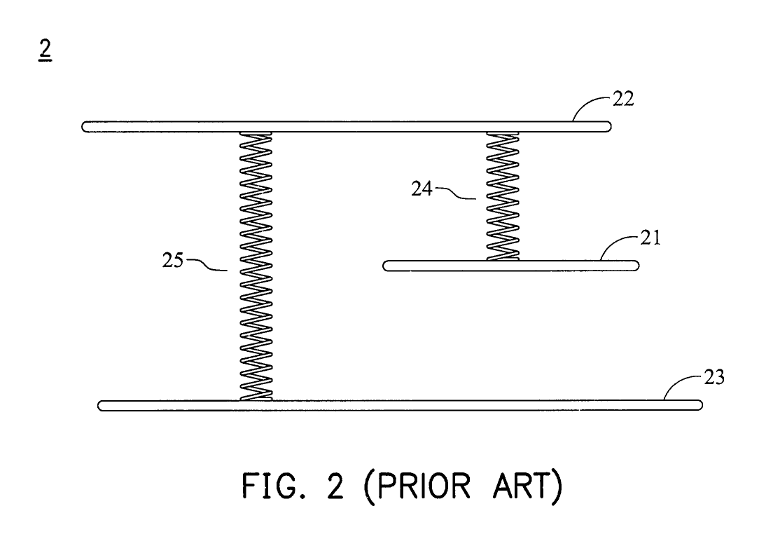

FIG. 3 is a perspective exploded view showing the suspension device of the invention;

FIG. 4 is a top view showing an optical disk drive having the suspension device of the invention;

FIG. 5 is a cross section taken along line A-A of FIG. 4;

FIG. 6 is a schematic view according to FIG. 5; and

FIG. 7 is a diagram showing vibration curves of the present suspension device when the mass center of the dynamic mass is in different positions.

### DETAILED DESCRIPTION OF THE INVENTION

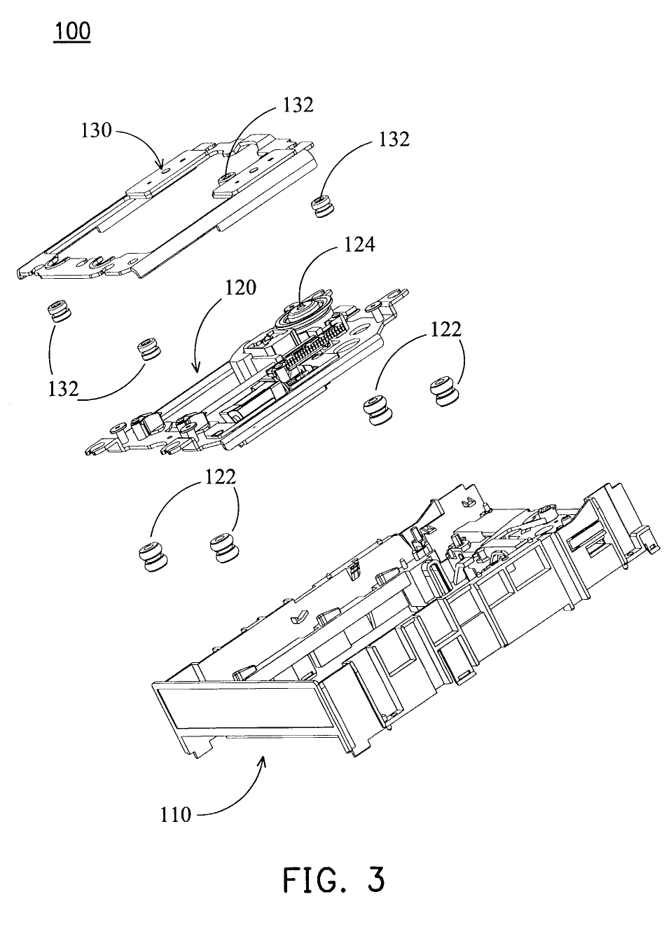

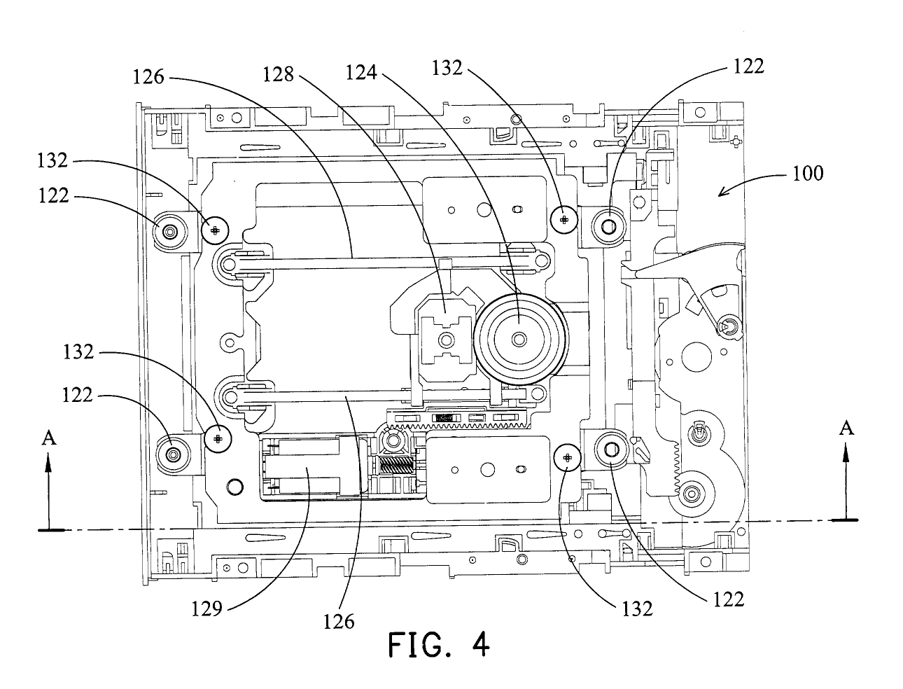

Referring to FIG. 3 and FIG. 4, the suspension device 100 for an optical media storage device comprises a loader 110, a traverse 120 and a dynamic mass 130. The traverse 120 is disposed on the loader 110 and four isolators 122 are disposed between the traverse 120 and the loader 110. The dynamic mass 130 is disposed on the traverse 120 and four dampers 132 are disposed between the dynamic mass 130 and the traverse 120. Additionally, a spindle motor 124, two parallel sliding tracks 126, an optical pick-up 128 and a DC servo motor 129 are disposed on the traverse 120.

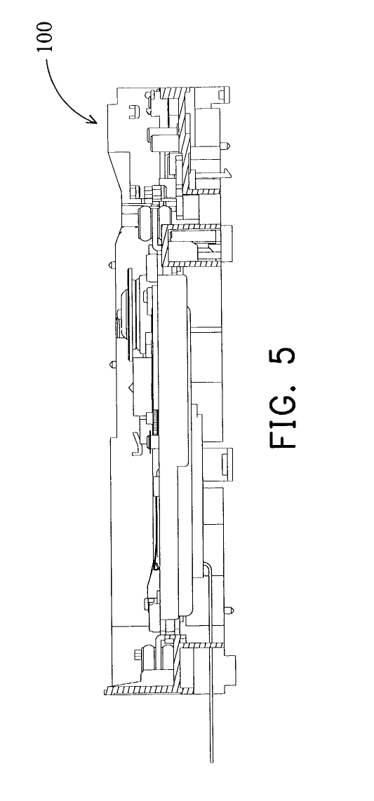

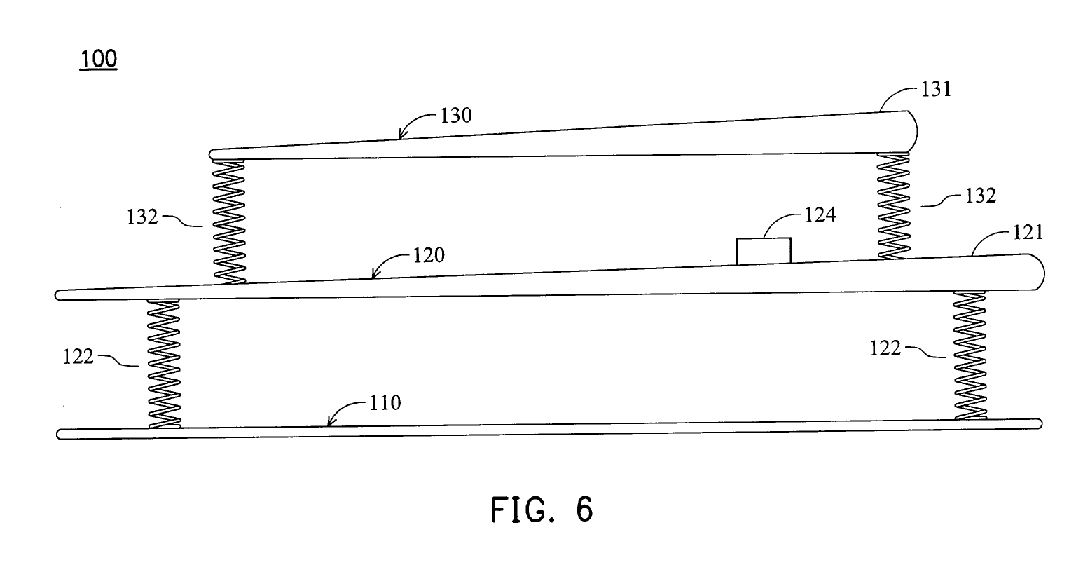

Referring to FIG. 4, FIG. 5 and FIG. 6, the traverse 120 has a first weighted end 121. The weight of the traverse 120 is not uniformly distributed over the traverse 120. The first weighted end 121 dominates major weight while the other end of the traverse 120 dominates minor weight. Thus, the mass center of the traverse 120 is close to the first weighted end 121. Meanwhile, the spindle motor 124 is disposed on the first weighted end 121. Similarly, the dynamic mass 130 has a second weighted end 131. The weight of the dynamic mass 130 is not uniformly distributed over the dynamic mass 130. The second weighted end 131 dominates major weight while the other end of the dynamic mass 130 dominates minor weight. Thus, the mass center of the dynamic mass 130 is close to the second weighted end 131. Specifically, the second weighted end 131 is located above the first weighted end 121.

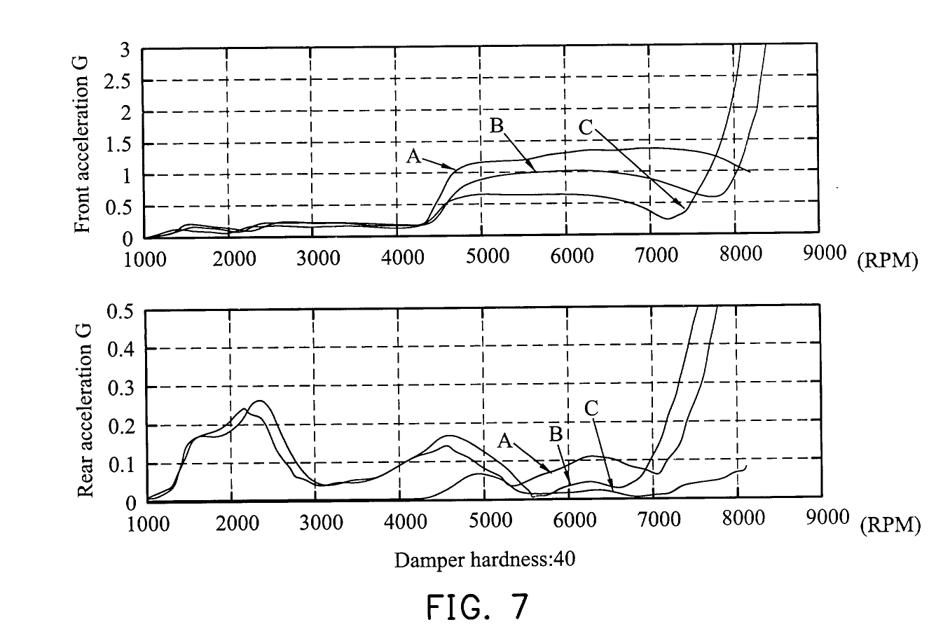

In order to demonstrate that the present suspension device 100 can effectively reduce vibration caused by the optical media storage device, vibration values generated by the spindle motor are measured and illustrated in FIG. 7. As shown in FIG. 7, X axis denotes rotation of the spindle motor (rpm), curve A represents that the mass center of the dynamic mass is far from the weighted end, curve B represents that the mass center of the dynamic mass is on the middle of the dynamic mass, curve C represents that the mass center of the dynamic mass is on the weighted end, and Y axis denotes front and rear vibration accelerations (G) of the suspension device.

As shown in FIG. 7, when the rotation of the spindle motor is below 7000 rpm and the mass center of the dynamic mass approaches the weighted end (front end), the vibration value becomes increasingly smaller (curve C).

Accordingly, the suspension device 100 uses the dynamic mass 130 whose mass center is close to the second weighted end 131 (front end). Thus, the vibration caused by the spindle motor 124 is reduced or eliminated effectively.

While the invention has been described by way of examples and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A suspension device for an optical media storage device having a spindle motor, comprising:
a loader;
a traverse disposed on the loader and having a first weighted end, wherein the mass center of the traverse is on the first weighted end and the spindle motor is disposed on the first weighted end; and
a dynamic mass disposed on the traverse and having a second weighted end, wherein the mass center of the dynamic mass is on the second weighted end and the second weighted end is located above the first weighted end,
whereby, when the spindle motor operates, the vibration of the suspension device is reduced tremendously.

2. The suspension device as claimed in claim 1, wherein the optical media storage device is an optical disk drive.

3. The suspension device as claimed in claim 1, wherein a plurality of isolators are disposed between the traverse and the loader, and the plurality of isolators are disposed close to the corners of the traverse.

4. The suspension device as claimed in claim 1, wherein a plurality of dampers are disposed between the dynamic mass and the traverse, and the plurality of dampers are disposed close to the positions of the isolators.

5. An optical media storage device, comprising:
a loader;
a traverse disposed on the loader and having a first weighted end, wherein the mass center of the traverse is on the first weighted end;
a dynamic mass disposed on the traverse and having a second weighted end, wherein the mass center of the dynamic mass is on the second weighted end and the second weighted end is located above the first weighted end;
a spindle motor disposed on the first weighted end of the traverse;
an optical pick-up; and
a driving motor disposed on the traverse to drive the optical pick-up.

6. The optical media storage device as claimed in claim 5, further comprising two parallel sliding tracks, wherein one end of each sliding track is fixed to the first weighted end of the traverse while the other end is fixed to the opposite end of the first weighted end.

7. The optical media storage device as claimed in claim 6, wherein the optical pick-up slides on the two parallel sliding tracks.

8. The optical media storage device as claimed in claim 5, further comprising a driving gear set connected to the optical pick-up and the driving motor, wherein the driving motor drives the optical pick-up to slide on the two parallel sliding tracks by the driving gear set.

9. The optical media storage device as claimed in claim 5, wherein the optical media storage device is an optical disk drive.

10. The optical media storage device as claimed in claim 5, wherein a plurality of isolators are disposed between the traverse and the loader, and the plurality of isolators are disposed close to the corners of the traverse.

11. The optical media storage device as claimed in claim 5, wherein a plurality of dampers are disposed between the dynamic mass and the traverse, and the plurality of dampers are disposed close to the positions of the isolators.

12. The optical media storage device as claimed in claim 5, wherein the driving motor is a DC servo motor.

13. The optical media storage device as claimed in claim 5, wherein the driving motor is a stepping motor.
